(19) United States
(12) Patent Application Publication
(10) Pub. No.: US 2025/0390915 A1
(43) Pub. Date: Dec. 25, 2025

(54) ADVERTISEMENT MANAGEMENT DEVICE, ADVERTISEMENT MANAGEMENT METHOD, AND RECORDING MEDIUM

(71) Applicant: NEC Corporation, Minato-ku, Tokyo (JP)

(72) Inventors: Shuhei MIZUGUCHI, Tokyo (JP); Kosei KOBAYASHI, Tokyo (JP); Shuei YAMADA, Tokyo (JP); Shintaro CHIKU, Tokyo (JP); Masanori KUKI, Tokyo (JP); Naoko FUKUSHI, Tokyo (JP)

(73) Assignee: NEC Corporation, Minato-ku, Tokyo (JP)

(21) Appl. No.: 18/881,362

(22) PCT Filed: Sep. 1, 2022
(86) PCT No.: PCT/JP2022/032948

§ 371 Date: Jan. 6, 2025

(51) Int. Cl. G06Q 30/0251

(52) U.S. Cl. CPC G06Q 30/0266

(57) ABSTRACT

An advertisement management device according to an aspect of the present disclosure includes: at least one memory storing instructions; and; at least one processor configured to execute the instructions to: acquire position information about a plurality of output device; acquire periphery information about a periphery of output device; compare an advertising condition specified by an advertising client and at least one of the position information and the periphery information; and associate the position information of each of output device with a comparison result from the comparison means and displaying the result on a map.

### TECHNICAL FIELD

The present disclosure relates to an advertisement management device, an advertisement management method, and a recording medium.

### BACKGROUND ART

PTL 1 discloses an advertisement display device that selects advertisement content based on position information, local time information, and attributes of people around a vehicle to which a distribution device is connected, distributes the advertisement content to the vehicle via a network, and displays the advertisement content on displays arranged on an outer surface and an inner surface of the vehicle.

PTL 2 discloses an advertisement display device capable of acquiring a captured image and position information of an own vehicle by an omnidirectional camera, estimating a gender and an age of a person present in the captured image, selecting advertisement information relevant to an attribute and the position information of the person, and displaying the selected advertisement information on a display of the own vehicle.

### CITATION LIST

### Patent Literature

PTL 1: JP 2021-512438 A

PTL 2: JP 2016-065938 A

### SUMMARY OF INVENTION

### Technical Problem

The following analysis is given by the inventor. There is a demand from an advertiser to deliver an advertisement target such as a thing or a service to a consumer appropriately and timely. For example, a business operator displays advertisement content on a digital signage in a commercial facility, a street, or the like to attract customers and advertise objects and services provided by the business operator.

In this regard, the distribution device that distributes the advertisement content of PTLs 1 and 2 is configured to distribute the advertisement content for each single vehicle and display the advertisement content on the display of the vehicle based on the position information, the local time information, and the attribute of people around the vehicle to which the distribution device is connected. For this reason, it is actually difficult for an advertiser to provide more appropriate advertisement content to a desired consumer.

An object of the present disclosure is to provide an advertisement management device, an advertisement management method, and a recording medium capable of providing appropriate advertisement content to a consumer.

### Solution to Problem

According to a first point of view, there is provided an advertisement management device including:
a position information acquisition means for acquiring position information about a plurality of advertisement display means;
a periphery information acquisition means for acquiring periphery information about a periphery of the advertisement display means;
a comparison means for comparing an advertising condition specified in advance by an advertising client and at least one of the position information and the periphery information; and
a display means for associating the position information of each of the advertisement display means with a comparison result of each of the advertisement display means and displaying the result on a map.

According to a second point of view, there is provided an advertisement management method including:
acquiring position information of a plurality of advertisement display means;
acquiring periphery information about a periphery of the advertisement display means;
comparing an advertising condition specified in advance by an advertising client with at least one of the position information and the periphery information; and
associating a result obtained in the comparing with position information of each of the advertisement display means, and displaying the result on a map.

According to a third point of view, there is provided a recording medium having stored therein a program causing a computer to execute:
acquiring position information of a plurality of advertisement display means;
acquiring periphery information about a periphery of the advertisement display means;
comparing an advertising condition specified in advance by an advertising client with at least one of the position information and the periphery information; and
associating a result obtained in the comparing with position information of each of the advertisement display means, and displaying the result on a map.

This program is input to a computer device via an input device or a communication interface from the outside, is stored in a storage device, and drives a processor according to a predetermined step or process. This program can display the processing result including the intermediate state for each stage via the display device as necessary, or can communicate with the outside via the communication interface. A computer device therefor typically includes a processor, a storage device, an input device, a communication interface, and a display device as necessary, which can be connected to each other by a bus. This program can be recorded in a computer-readable (non-transitory) storage medium.

### Advantageous Effects of Invention

According to the present disclosure, appropriate advertisement content can be provided to a consumer.

### BRIEF DESCRIPTION OF DRAWINGS

FIG. 1 is a diagram illustrating an example of a configuration of an example embodiment of the present disclosure and an image displayed on a display means.

FIG. 2 is a flowchart illustrating operation of an example embodiment of the present disclosure.

FIG. 3 is a diagram illustrating a configuration of an advertisement management device according to a first example embodiment of the present disclosure.

FIG. 4 is a table illustrating advertising conditions 1 to 3 requested by an advertiser.

FIG. 5 is a diagram illustrating an example of an image displayed on a display unit of the advertisement management device according to the first example embodiment of the present disclosure.

FIG. 6 is a diagram illustrating an example of presenting advertisement content to a person in a vehicle using the advertisement management device according to the first example embodiment of the present disclosure.

FIG. 7 is a table illustrating element attributes estimated by the advertisement management device.

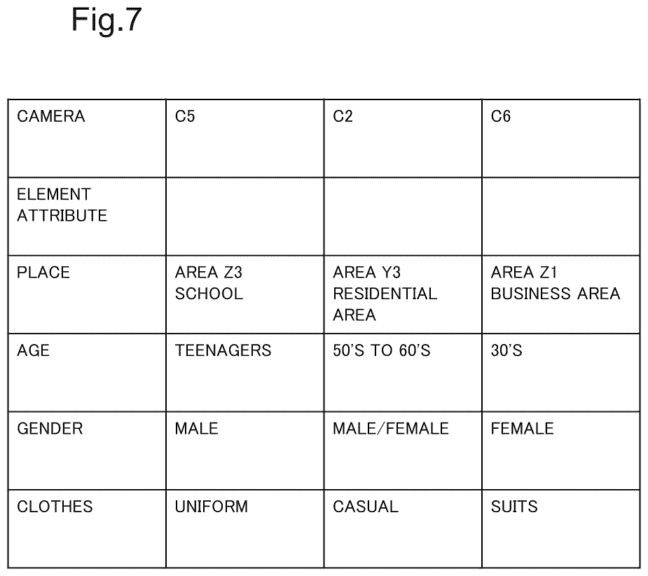

FIG. 8 is a diagram for explaining an advertisement management method by the advertisement management device according to the first example embodiment of the present disclosure.

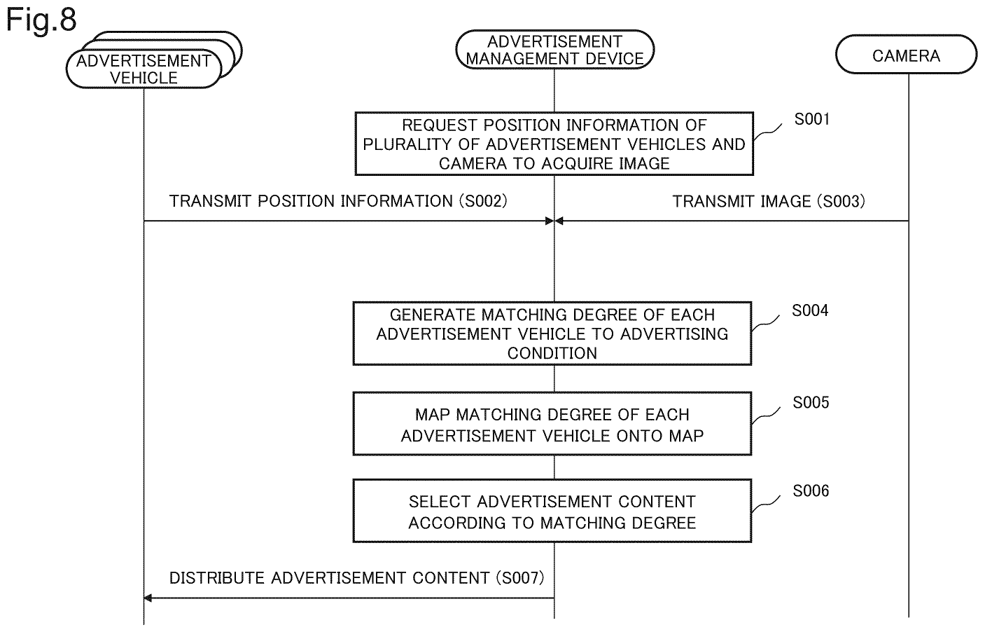

FIG. 9 is a diagram for explaining an example in which an advertisement management device according to a second example embodiment of the present disclosure is applied to a movie theater.

FIG. 10 is a diagram illustrating an example of an image displayed on a display unit of the advertisement management device according to the second example embodiment of the present disclosure.

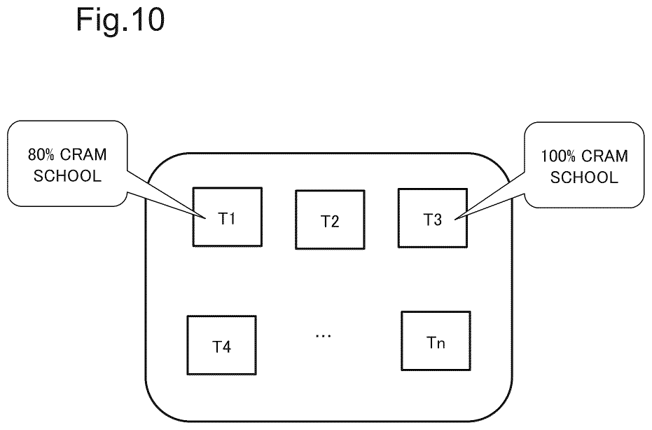

FIG. 11 is a diagram illustrating a configuration of a computer constituting the advertisement management device of the present disclosure.

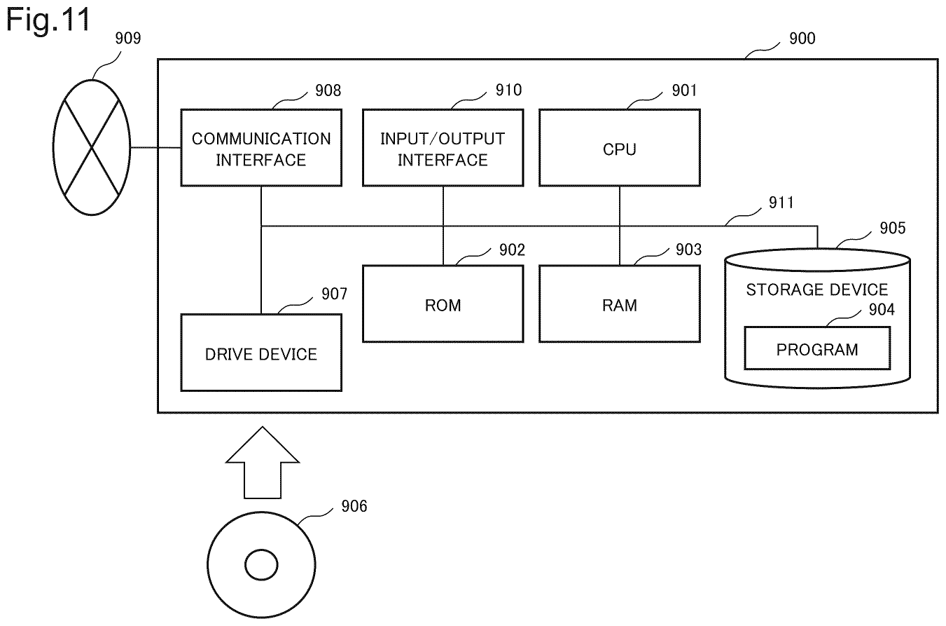

### EXAMPLE EMBODIMENT

First, an outline of an example embodiment of the present disclosure will be described with reference to the drawings. The reference numerals in the drawings attached to this outline are attached to each element for convenience as an example for assisting understanding, and are not intended to limit the present invention to the illustrated aspects. Connection lines between blocks in the drawings and the like referred to in the following description include both bidirectional and unidirectional. The unidirectional arrow schematically indicates a flow of a main signal (data), and does not exclude bidirectionality. The program is executed via a computer device, and the computer device includes, for example, a processor, a storage device, an input device, a communication interface, and a display device as necessary. The computer device is configured to be able to communicate with a device (including a computer) inside or outside the device via a communication interface regardless of wired or wireless. Although there are ports and interfaces at connection points of input and output of each block in the drawing, they are not illustrated.

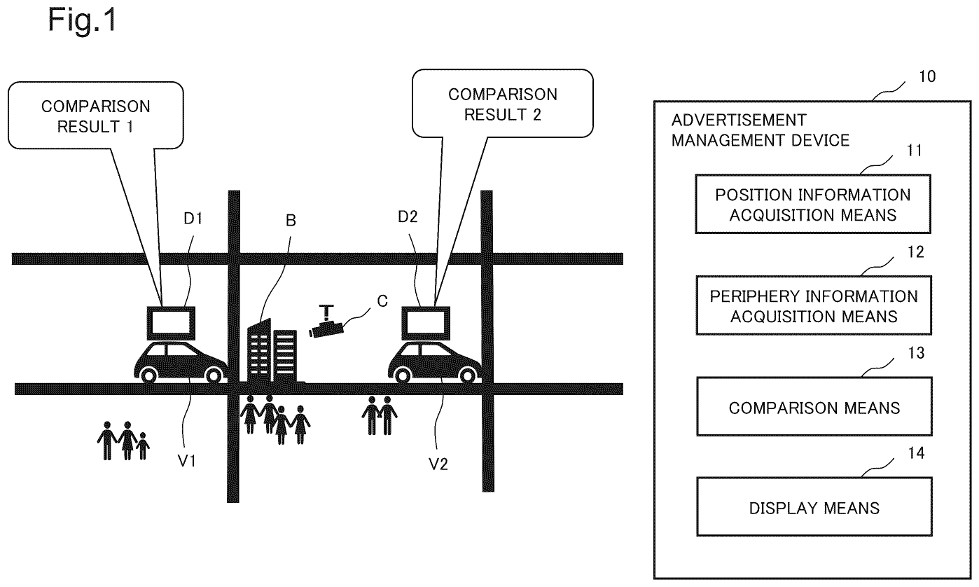

As illustrated in FIG. 1, an example embodiment of the present disclosure is an advertisement management device 10 including a position information acquisition means 11, a periphery information acquisition means 12, a comparison means 13, and a display means 14. The position information acquisition means 11 acquires current location information of a plurality of advertisement display means for displaying advertisement content. In a case where the advertisement display means D1 and D2 are mounted inside or outside vehicles V1 and V2, the position information obtained from a known navigation device using a GPS signal is used to specify the position of the vehicle. As a method by which the position information acquisition means 11 acquires position information from the vehicles V1 and V2, a method via a mobile communication network such as a fifth generation mobile communication system or long term evolution (LTE), a method via a roadside unit, or the like can be considered. As a method of acquiring the position information of the position information acquisition means 11, the advertisement vehicles V1 and V2 may actively transmit the position information at predetermined time intervals, or the position information acquisition means 11 may request the advertisement vehicles V1 and V2 to transmit the position information.

The periphery information acquisition means 12 acquires periphery information about the periphery of the advertisement display means D1 and D2. The periphery information is information on people around the advertisement display means D1 and D2, and the number of people, attributes thereof, and the like are diffracted based on image information captured by the camera.

The comparison means 13 compares the advertising condition specified in advance by an advertising client with at least one of the position information on the advertisement display means D1 and D2 and the periphery information, and generates a comparison result.

The display means 14 displays the comparison result generated by the comparison means 13 in association with the position information of each of the advertisement display means D1 and D2.

A camera C used in the periphery information acquisition means 12 may be a fixed camera or a pan tilt zoom (PTZ) camera. Image information about the periphery of the camera may be acquired using an omnidirectional camera capable of capturing an image or a moving image of 360 degrees.

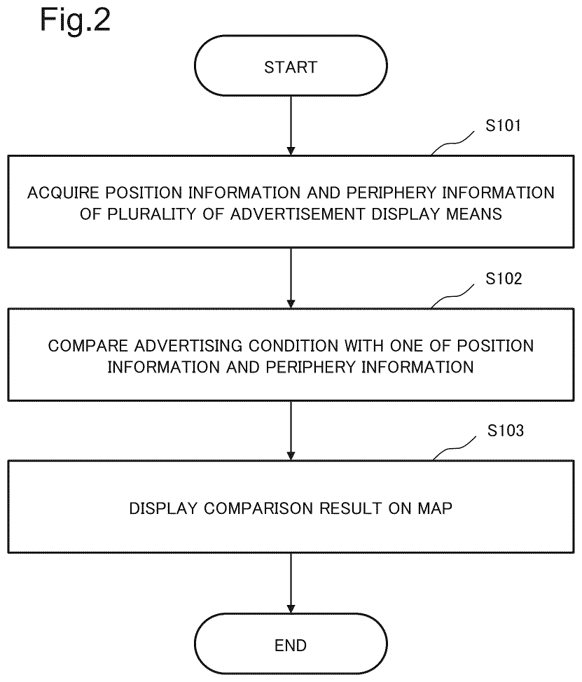

The advertisement management device 10 operates as follows. When the advertisement management device 10 is activated, the position information of the plurality of advertisement display means D1 and D2 is acquired (S101 in FIG. 2). Since the advertisement display means D1 and D2 are configured to be mounted outside the vehicles V1 and V2, the advertisement display means D1 and D2 are acquired from the position information of the vehicles V1 and V2 using an in-vehicle navigation device. The periphery information acquisition means 12 acquires periphery information about the periphery of the plurality of advertisement display means D1 and D2 (S101 in FIG. 2). For example, based on an image acquired and transmitted by the camera C installed in a street, periphery information regarding the number and attributes of people about the periphery of the advertisement display means D1 and D2 is acquired (S101 in FIG. 2).

Next, the comparison means 13 compares the advertising condition specified in advance by the advertising client with at least one of the position information and the periphery information to generate a comparison result (S102 in FIG. 2). Comparison results 1 and 2 of the advertisement display means D1 and D2 are associated with the position information of the advertisement display means D1 and D2, and displayed on a map (S103 in FIG. 2). Based on the displayed comparison results 1 and 2, the user of the advertisement management device 10 can execute management such as distribution and stop of advertisement content presented for each of the plurality of advertisement display means.

In FIG. 1, the comparison results 1 and 2 regarding the advertisement display means D1 and D2 are shown on the map in such a manner that position information of the advertisement display means D1 and D2 is associated with the comparison results 1 and 2 by using balloon lines. However, the method of associating the position information with the comparison result is not limited to the display method illustrated in FIG. 1, and can be arbitrarily changed as long as the comparison result and the current position of the advertisement display means relevant to the comparison result can be recognized.

The advertisement display means D1 and D2 are signages capable of expressing advertisement content, and include a display or a projector capable of displaying a still image or a moving image, a speaker capable of expressing a voice, and the like. More specifically, the advertisement display means is not limited to a signboard or a display that is placed on an outer surface or an inner surface of the advertisement vehicles V1 to V2 and is movable, a signboard or a display that is fixedly arranged on an outer wall or an inner side of a public or private facility, or on a street, and includes a screen installed in a movie theater, a theater, an attraction facility of a theme park, or the like. The advertisement vehicle is not limited to a truck that presents an advertisement on a side surface (outer surface) of a mount mainly for the purpose of advertising or publicity of a matter desired to be promoted, and includes a taxi, a bus, a railway vehicle, an airplane, a two-wheeled vehicle, a bicycle, a kick board, and the like that can present an advertisement outside or inside the vehicle.

In the above-described example embodiment, the configuration in which the advertisement display means is arranged outside the vehicle has been described, and the periphery information acquisition means has been described as a configuration using the periphery information regarding the person existing outside the vehicle, but the comparison result may be generated using the periphery information regarding the person existing inside the vehicle. Similarly, in the case of a configuration in which the advertisement display means is arranged inside the vehicle, the periphery information acquisition means uses at least one of a person present inside the vehicle and a person present outside the vehicle as the periphery information to acquire the comparison result.

In the above example embodiment, the comparison result is acquired by the comparison means using the position information and the periphery information, but it is also possible to compare only one of the position information and the periphery information with the advertising condition. For example, in a case where the advertisement display means is fixedly placed, since the position information can be grasped in advance, it is also possible to acquire periphery information of the advertisement display means and compare the periphery information with the advertising conditions. Depending on the advertising condition, in a case where the purpose is to display an advertisement to a person in a specific place (for example, a person who comes to a bathing place), when the position information of the advertisement display means is emphasized, the advertising condition may be compared with the position information.

### First Example Embodiment

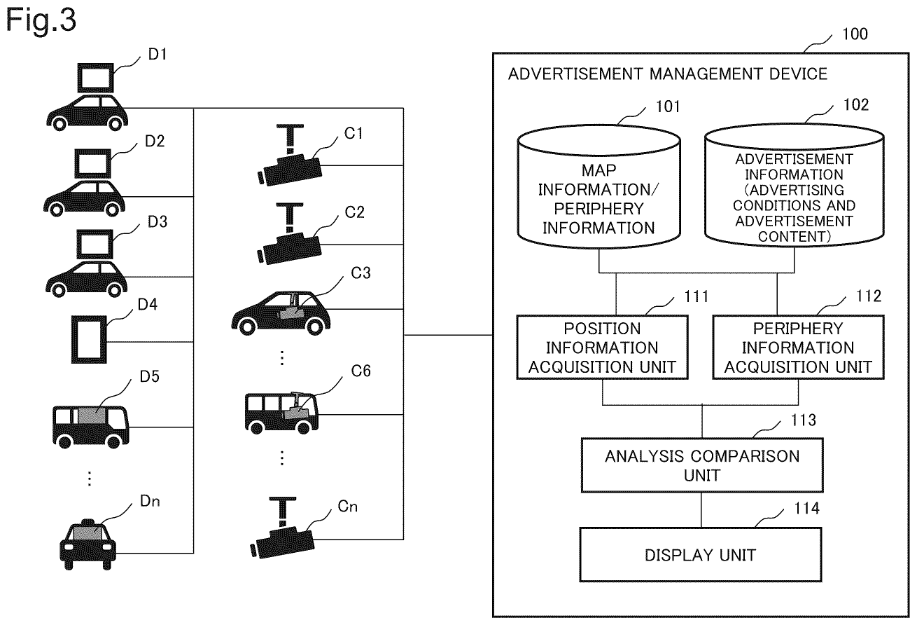

A first example embodiment will be described which is an advertisement management device 100 that mainly uses an advertisement vehicle to display advertisement content. As illustrated in FIG. 3, the advertisement management device 100 includes a database 101 that stores map information and periphery information, a database 102 that stores advertising conditions and advertisement content requested in advance by an advertiser, a position information acquisition unit 111 relevant to the position information acquisition means 11, a periphery information acquisition unit 112 relevant to the periphery information acquisition means 12, an analysis comparison unit 113 relevant to the comparison means 13, and a display unit 114 relevant to the display means 14.

In order to specify the current location where the advertisement vehicles V1 to V3 are currently traveling, the position information acquisition unit 111 specifies the position of the vehicle using position information obtained from known navigation devices mounted on the advertisement vehicles V1 to V3 using a GPS signal. As a method by which the position information acquisition unit 111 acquires position information from the advertisement vehicles V1 to V3, a method via a mobile communication network such as a fifth generation mobile communication system or long term evolution (LTE), a method via a roadside unit, or the like can be considered. As a method of acquiring the position information of the vehicle, the advertisement vehicles V1 to V3 may actively transmit the position information at predetermined time intervals, or the position information acquisition unit 111 may request the advertisement vehicles V1 to V3 to transmit the position information.

The periphery information acquisition unit 112 of the present example embodiment acquires image information acquired by the cameras C1, C2, C4, and C5 arranged at predetermined positions and the movable cameras C3 and C6 mounted on the vehicles V3 and V4, and converts the image information into image information that can be processed by the analysis comparison unit 113 described later. The cameras C1 to C7 may be, for example, fixed cameras or pan tilt zoom (PTZ) cameras. The cameras C1 to C7 may use an omnidirectional camera capable of capturing an image or a moving image of 360 degrees to acquire image information about the periphery of the camera.

In the present example embodiment, the advertisement vehicles V1, V2, and V4 themselves do not include a camera that acquires periphery information of the advertisement vehicle. However, since the movement and flow of the person in the periphery of the advertisement vehicle change from moment to moment, the accuracy of the estimation of the matching in the comparison unit described later can be improved by providing the image cameras in the advertisement vehicles V1, V2, and V4 and acquiring the periphery information. The advertisement vehicle V4 is a bus that can accommodate passengers, and includes a display D5 for presenting advertisements to the passengers, and a camera C6 for acquiring periphery information in the vehicle.

The analysis comparison unit 113 constituting the comparison means 13 has an analysis function of analyzing an image and a comparison function of comparing collected periphery information and an advertising condition requested in advance by an advertiser. The analysis comparison unit 113 acquires image information from the cameras C1 to C7 processed by the periphery information acquisition unit 112, and analyzes the number and attributes of people appearing in the image information. The position information about the position where the image information is acquired is also acquired from the moving cameras C3 and C6.

In order to analyze the attribute of the person appearing in the image information, the analysis comparison unit 113 generates attribute data such as the number of people, age, gender, and clothes by converting the flow line and the attribute of the person into data and analyzing the data using a known human flow analysis method. The analysis comparison unit 113 may generate the attribute data in a form not including the image from the viewpoint of privacy. Similarly to the above-described advertisement vehicles V1 to V3, a known navigation device is mounted on the vehicle on which the camera C3 is mounted, and position information is associated with image information acquired by the camera C3.

The analysis comparison unit 113 has a comparison function of comparing the periphery information provided from the position information acquisition unit 111 and the periphery information acquisition unit 112 of the advertisement vehicles V1, V3, and V4 with the advertising conditions specified in advance by the advertiser, and calculating a matching degree between the two.

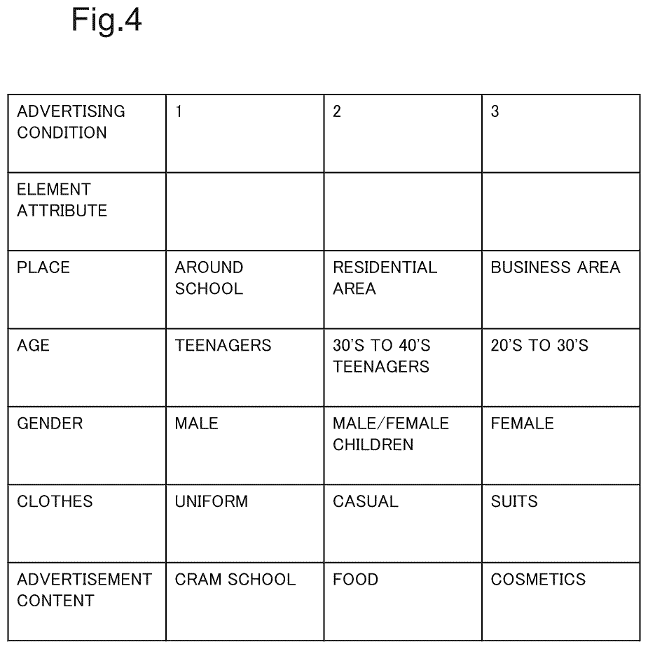

Hereinafter, an example of a comparison function of the analysis comparison unit 113 will be described. FIG. 4 illustrates advertising conditions 1 to 3 requested by the advertiser. The advertising condition includes an element attribute for specifying a type of advertisement content and a person who is a target to which the advertisement content is presented. For example, the advertisement content of the advertising condition 1 relates to a cram school, and the places, ages, genders, and clothes that are the element attributes of the advertising condition 1 are around school, teenagers, men, and uniforms.

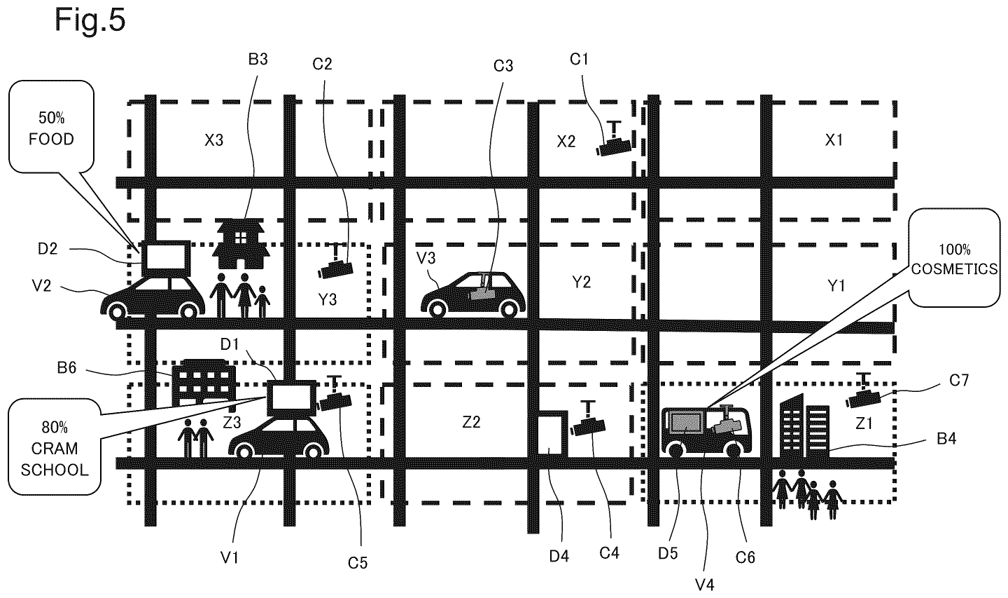

FIG. 5 illustrates an example of an image displayed on the display unit 114 of the advertisement management device 100 according to the first example embodiment. A region displayed on the map in FIG. 5 is divided into a plurality of areas, and reference numerals X1 to X3, Y1 to Y3, and Z1 to Z3 are allocated to the areas (rectangular regions indicated by broken lines). For example, ages, genders, and clothes are identified from the image acquired by the camera C5 arranged in an area Z3 among the four element attributes. The position of the camera C5 refers to map information stored in advance in the database 101, and acquires information of a school B6 existing at the relevant position. For example, when the element attribute of the advertising condition 1 illustrated in FIG. 4 can be estimated from the image information acquired by the camera C5, the estimated element attribute is compared with the element attribute of the advertising condition, and the matching degree is calculated.

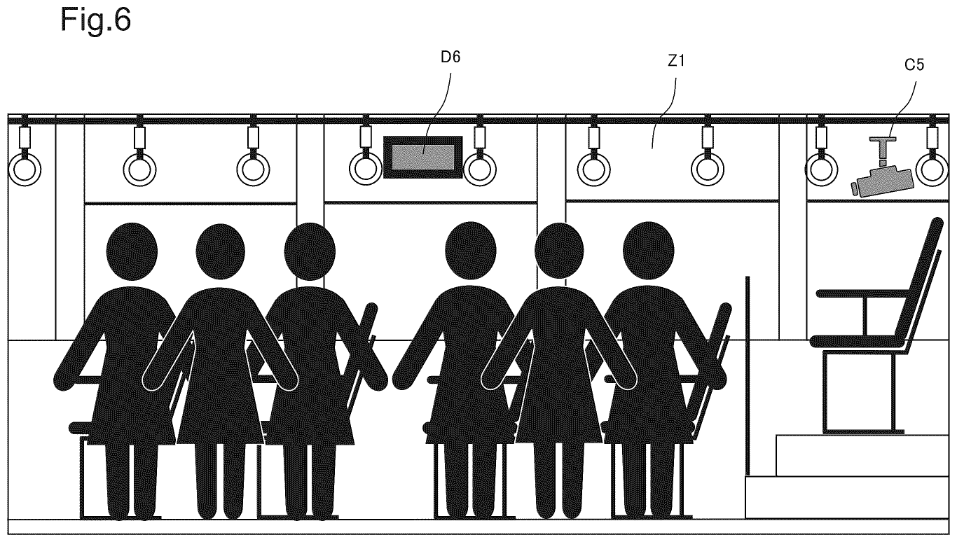

As illustrated in FIG. 6, in the advertisement vehicle V4, advertisement content is displayed by the display D5 placed in the vehicle. In this case, the periphery information is acquired based on the image information by the camera C6 placed in the vehicle. Since advertisement vehicle V4 is traveling in the area Z1 (see FIG. 5), the inside of the vehicle is also recognized as the area Z1.

As the matching degree, a known calculation method can be used. For example, the evaluation value as to whether the element attributes match is represented by two values of 1 or 0, and the weight of “place”, “age”, “gender”, and “clothes”, which are the element attributes, is set to 0.2, 0.3, 0.3, and 0.2. Here, in a case where the estimated evaluation value of “place”, “age”, and “gender” is 1 and the evaluation value of “clothes” is 0, the matching degree in the area Z3 is 0.8 (80%). For example, in a case where the threshold for selecting appropriateness/inappropriateness of advertising is 80%, an advertiser or an operator issues a command to present advertisement content on the display D1 of the vehicle V1. Of course, a configuration in which a threshold of the matching degree is set in advance, and predetermined advertisement content is distributed and presented to a display arranged or traveling in an area exceeding the threshold can also be applied. In the present example embodiment, the matching degree is expressed by percent (%), but a configuration in which the matching degree is expressed by symbols such as o (circle mark), Δ (triangle mark), and x (cross mark) can also be applied. For example, a numerical range of the matching degree is set for each of o, Δ, and x, and expressed by symbols such as o, Δ, and x, whereby the user can easily recognize the degree of the matching degree.

The displays D1, D2, D4, and D5 mounted outside the advertisement vehicle illustrated in FIG. 5 are configured to present advertisement content to a person walking outdoors, but there is also a configuration in which advertisement content is presented to a passenger such as a taxi, a bus, or a train by using a display disposed inside the vehicle. FIG. 6 illustrates an example in which advertisement content is presented by the display D5 placed in the vehicle V4. In this case, the periphery information is acquired based on the image information by the camera C6. Since the advertisement vehicle V4 is traveling in the area Z1 (see FIG. 5), the inside of the vehicle is also recognized as the area Z1, and the matching degree is calculated.

In the case of the advertising condition 3, when the matching degree is calculated, the matching degree in the area Z3 is 100%. In this case, the evaluation value of the element attributes “place”, “gender”, “age”, and “clothes” estimated based on the periphery information acquired by the camera C6 is 1, and the matching degree is 100%.

In the case of the advertising condition 2, as in the advertising condition 1, when the matching degree is calculated, the matching degree in the area Y3 is 0.5. The evaluation value of “place” and “gender” estimated based on the periphery information acquired by the camera C2 is 1, the evaluation value of “age” and “clothes” is 0, and the matching degree is 50%.

In the present example embodiment, four element attributes are used when calculating the matching degree, but the number of element attributes can be appropriately increased or decreased. For example, weather information, event information, and the like of a place where a matching degree is estimated are exemplified. In a case where weather information or event information can be acquired from a communication network via a communication interface included in the advertisement management device 100, the event information can also be used as an element attribute.

It is also possible to use a walking speed or a walking direction of a person as an element attribute used for comparing the matching degree. For example, in a case where a function of setting an advertisement rate to be charged to an advertiser is provided, an advertisement cost in a case where a traveling speed of a person exceeds a threshold may be configured to be lower than an advertisement cost in a case where the traveling speed does not exceed the threshold.

### Second Example Embodiment

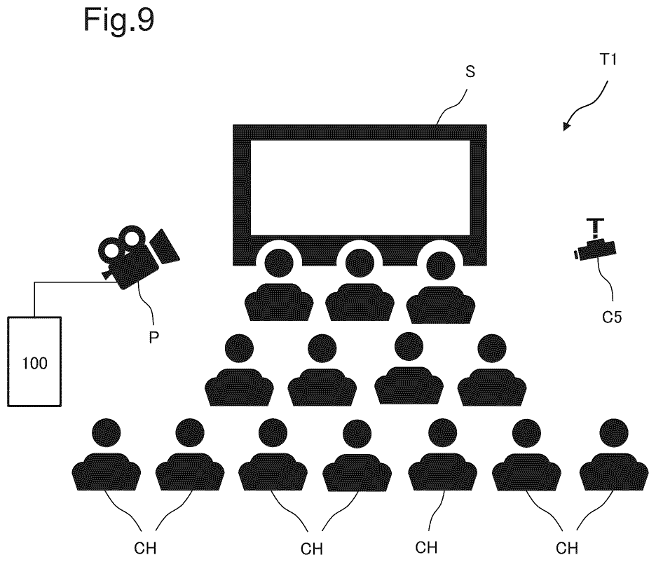

The second example embodiment is an example in which an advertisement management device is applied to a substantially closed space facility such as a movie theater, a theater, or a theme park. The present example embodiment is different from the first example embodiment in which the target person to whom the advertisement content is presented does not substantially move for a certain period of time, and the advertisement content is presented to a person in a moving situation. For example, a movie theater includes a screen S for showing a movie, a projector P for projecting a movie on the screen S, a camera C5 for acquiring an image of viewers, and chairs CH on which the viewers sit. The periphery information is acquired from the image by the camera C5, the attribute of the viewers is analyzed, the matching degree between the element attribute of the viewers and the element attribute of the advertising condition is calculated, and displayed on the layout images of the theaters T1 to Tn (see FIG. 9). In a case where the matching degree exceeds a predetermined threshold, the advertisement content can be set to be displayed on the screen S via the projector P.

When the advertisement management device of the present disclosure is applied to a complex facility including a plurality of theaters T1 to Tn, matching degrees of viewers of the theaters T1 to Tn can be collectively recognized, so that advertisement content presented to the theaters T1 to Tn can be collectively managed (see FIG. 9).

### Hardware Configuration

In each example embodiment of the present disclosure, each component of each device indicates a block in units of function. A part or all of each component of each device is achieved by, for example, an arbitrary combination of an information processing device 900 and a program as illustrated in FIG. 9. FIG. 9 is a block diagram illustrating an example of a hardware configuration of the information processing device 900 that implements each component of each device. As an example, the information processing device 900 includes the following configurations.
CPU (Central Processing Unit) 901
ROM (Read Only Memory) 902
RAM (Random Access Memory) 903
Program 904 loaded into RAM 903
Storage device 905 storing program 904
Drive device 907 that reads and writes recording medium 906
Communication interface 908 connected with communication network 909
Input/output interface 910 for inputting/outputting data
Bus 911 connecting each component

Each component of each device in each example embodiment is achieved by the CPU 901 acquiring and executing a program 904 for achieving these functions. That is, the CPU 901 of FIG. 16 may execute the information collection program and the reproduction image program to perform update processing of each calculation parameter held in the RAM 903, the storage device 905, or the like. The program 904 for achieving the function of each component of each device is stored in the storage device 905 or the ROM 902 in advance, for example, and is read by the CPU 901 as necessary. The program 904 may be supplied to the CPU 901 via the communication network 909, or may be stored in advance in the recording medium 906, and the drive device 907 may read the program and supply the program to the CPU 901.

There are various modifications of the method of achieving each device. For example, each device may be achieved by any combination of the information processing device 900 and the program separate for each component. A plurality of components included in each device may be achieved by any combination of one information processing device 900 and a program. That is, each unit (processing means and function) of the event image creation device described in the above first to third example embodiments can be achieved by a computer program that causes a processor mounted on the device to execute each processing described above using its hardware.

Some or all of the constituent elements of each device are achieved by other general-purpose or dedicated circuits, processors and the like, or a combination thereof. These may be configured by a single chip or may be configured by a plurality of chips connected via a bus.

Some or all of the components of each device may be achieved by a combination of the above-described circuit and the like and a program.

In a case where some or all of the components of each device are achieved by a plurality of information processing devices, circuits, and the like, the plurality of information processing devices, circuits, and the like may be arranged in a centralized manner or in a distributed manner. For example, the information processing device, the circuit, and the like may be achieved as a form in which each is connected via a communication network, such as a client and server system or a cloud computing system.

Each of the above-described example embodiments is a preferred example embodiment of the present disclosure, and the scope of the present disclosure is not limited only to each of the above-described example embodiments. That is, it is possible for those skilled in the art to make modifications and substitutions of the above-described example embodiments without departing from the gist of the present disclosure, and to construct a mode in which various modifications are made.

Some or all of the above example embodiments may be described as the following Supplementary Notes, but are not limited to the following.

### Supplementary Note 1

An advertisement management device including:
a position information acquisition means for acquiring position information about a plurality of advertisement display means;
a periphery information acquisition means for acquiring periphery information about the periphery of the advertisement display means;
a comparison means for comparing an advertising condition specified in advance by an advertising client and at least one of the position information and the periphery information, and acquiring a matching degree; and
a display means for associating the position information of each of the advertisement display means with the comparison result from the comparison means and displaying the result on a map.

### Supplementary Note 2

The advertisement display means can display advertisement content based on the comparison result.

### Supplementary Note 3

The comparison result is a matching degree.

### Supplementary Note 4

In a case where the matching degree exceeds a predetermined threshold,
the advertisement display means can display advertisement content relevant to a matching degree exceeding the threshold.

### Supplementary Note 5

The map can be divided into a plurality of areas, and the comparison means can acquire a matching degree for each of the areas.

### Supplementary Note 6

The advertisement display means can display the matching degree for each of the areas.

### Supplementary Note 7

The advertisement display means can display a type of the advertisement content.

### Supplementary Note 8

The advertising condition can include a type of the advertisement content and an element attribute.

### Supplementary Note 9

An advertisement management method including:
acquiring position information of a plurality of advertisement display means;
acquiring periphery information about a periphery of the advertisement display means;
comparing an advertising condition specified in advance by an advertising client with at least one of the position information and the periphery information; and
associating a result obtained in the comparing with position information of each of the advertisement display means, and displaying the result on a map.

### Supplementary Note 10

A recording medium having stored therein a program causing a computer to execute:
acquiring position information of a plurality of advertisement display means;
acquiring periphery information about a periphery of the advertisement display means;
comparing an advertising condition specified in advance by an advertising client with at least one of the position information and the periphery information; and
associating a result obtained in the comparing with position information of each of the advertisement display means, and displaying the result on a map.

The forms of the above-described Supplementary Notes 9 and 10 can be developed to the forms of Supplementary Notes 2 to 8, similarly to Supplementary Note 1.

The disclosures of the above patent documents are incorporated herein by reference, and can be used as a basis or part of the present disclosure as necessary. Within the frame of the entire disclosure (including claims) of the present disclosure, it is possible to change and adjust the example embodiments or examples further based on the basic technical idea. Various combinations or selections (including partial deletions) of various disclosure elements (each element of each claim, each element of each example embodiment or example, each element of each drawing, and the like are included) can be made within the frame of the present disclosure. That is, it is a matter of course that the present disclosure includes various modifications and corrections that can be made by those of ordinary skill in the art in accordance with the entire disclosure including the claims and the technical idea. In particular, for numerical ranges set forth herein, any numerical value or sub-range included within the range should be construed as being specifically described, even if not stated otherwise. It is also deemed that the disclosure of the present application includes use of some or all of the disclosed matters of the cited documents as part of the present disclosure in combination with the described matters of the present disclosure in accordance with the gist of the present disclosure as necessary.

### REFERENCE SIGNS LIST

10 advertisement management device
11 position information acquisition means
12 periphery information acquisition means
13 comparison means
14 display means
100 advertisement management device
111 position information acquisition unit
112 periphery information acquisition unit
113 analysis comparison unit
114 display unit
900 information processing device
901 CPU (Central Processing Unit)
902 ROM (Read Only Memory)
903 RAM (Random Access Memory)
904 program
905 storage device
906 recording medium
907 drive device
908 communication interface
909 communication network
910 input/output interface
911 bus
C1 to Cn camera
D1 to Dn advertisement display means (display)
V1 to V4 vehicle
S screen

What is claimed is:

1. An advertisement management device comprising:
at least one memory storing instructions; and
at least one processor configured to execute the instructions to:
acquire position information about a plurality of output device;
acquire periphery information about a periphery of output device;
compare an advertising condition specified by an advertising client and at least one of the position information and the periphery information; and
associate the position information of each of output device with a comparison result from the comparison means and displaying the result on a map.

2. The advertisement management device according to claim 1, wherein the at least one processor is further configured to execute the instructions to: display advertisement content based on the comparison result.

3. The advertisement management device according to claim 1, wherein the comparison result is a matching degree.

4. The advertisement management device according to claim 1, wherein the at least one processor is further configured to execute the instructions to:
in a case where the matching degree exceeds a predetermined threshold,
display advertisement content relevant to a matching degree exceeding the threshold.

5. The advertisement management device according to claim 2, wherein the at least one processor is further configured to execute the instructions to:
acquire a matching degree for each of the areas what the map is divided into a plurality of areas.

6. The advertisement management device according to claim 5, wherein the at least one processor is further configured to execute the instructions to: display the matching degree for each of the areas.

7. The advertisement management device according to claim 2, wherein the at least one processor is further configured to execute the instructions to: display a type of the advertisement content.

8. The advertisement management device according to claim 1, wherein the advertising condition includes a type of the advertisement content and an element attribute.

9. An advertisement management method comprising:
acquiring position information of a plurality of output device;
acquiring periphery information about a periphery of the output device;
comparing an advertising condition specified in advance by an advertising client with at least one of the position information and the periphery information; and
associating a result obtained in the comparing with position information of each of output device, and displaying the result on a map.

10. A non transitory recording medium having stored therein a program causing a computer to execute:
acquiring position information of a plurality of output device;
acquiring periphery information about a periphery of output device;
comparing an advertising condition specified in advance by an advertising client with at least one of the position information and the periphery information; and
associating a result obtained in the comparing with position information of each of output device, and displaying the result on a map.

11. The advertisement management device according to claim 2, wherein the at least one processor is further configured to execute the instructions to:
acquire a matching degree for each of the areas what the map is divided into a plurality of areas.

12. The advertisement management device according to claim 3, wherein the at least one processor is further configured to execute the instructions to:
acquire a matching degree for each of the areas what the map is divided into a plurality of areas.

13. The advertisement management device according to claim 4, wherein the at least one processor is further configured to execute the instructions to:
acquire a matching degree for each of the areas what the map is divided into a plurality of areas.
